(19) United States
(12) Patent Application Publication
(10) Pub. No.: US 2008/0249903 A1
(43) Pub. Date: Oct. 9, 2008

(54) LONGEVITY AND MORTALITY INDICES AND ASSOCIATED TRADABLE FINANCIAL PRODUCTS

(75) Inventors: Gilles Dellaert, Brooklyn, NY (US); Alexander A. Dubitsky, Larchmant, NY (US); Charles McGarraugh, Brooklyn, NY (US); Philip Sherrill, New York, NY (US); Andrew Howard Plevin, New York, NY (US)

Correspondence Address: LEE & HAYES, PLLC, 421 W. RIVERSIDE AVE., SUITE 500, SPOKANE, WA, 99201, US

(73) Assignee: Goldman, Sachs & Co., New York, NY (US)

(21) Appl. No.: 12/098,096

(22) Filed: Apr. 4, 2008

Related U.S. Application Data
(60) Provisional application No. 60/910,421, filed on Apr. 5, 2007.

(51) Int. Cl. G06Q 90/00; G06Q 40/00

(52) U.S. Cl. 705/30; 705/4

(57) ABSTRACT

The document describes creation of one or more families of longevity and mortality indices, some or all of which may be tradable. In addition, this document describes tradable derivatives and other financial products whose value or payment obligations may be tied in some manner to one or more of the created longevity and mortality indices.

### RELATED APPLICATIONS

This application claims the benefit of U.S. Provisional Application No. 60/910,421 (GS1-0027USP1), filed Apr. 5, 2007, which is incorporated by reference herein.

### BACKGROUND

A life settlement is a financial transaction that allows a life insurance policyholder to sell an unwanted life insurance policy to another party for more money that the life insurance company itself offers the policyholder. A life settlement market therefore allows policyholders to assess fair market value of their life insurance policies. This in turn allows policyholders to avoid accepting lower than fair-market-value buyback offers from the issuing life insurance companies.

In addition, the life-settlement market allows investors to buy individual life insurance policies for investment purposes. These policies essentially function as a negative coupon bond, where the new policyholder pays cash flow for the policy on a periodic basis. The new policyholder or assigned beneficiary of the policy then receives a death benefit or payout at a time of death of the insured. While the life settlement market interests investors, many of these investors do not have adequate information to feel comfortable enough to invest in the life settlement market.

### SUMMARY

The document describes creation of one or more families of longevity and mortality indices. In addition, this document describes tradable financial products whose value or payment obligations may be tied in some manner to one or more of the created longevity and mortality indices.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

### BRIEF DESCRIPTION OF THE CONTENTS

The detailed description is described with reference to accompanying figures. In the figures, the left-most digit(s) of a reference number identifies the figure in which the reference number first appears. The use of the same reference numbers in different figures indicates similar or identical items.

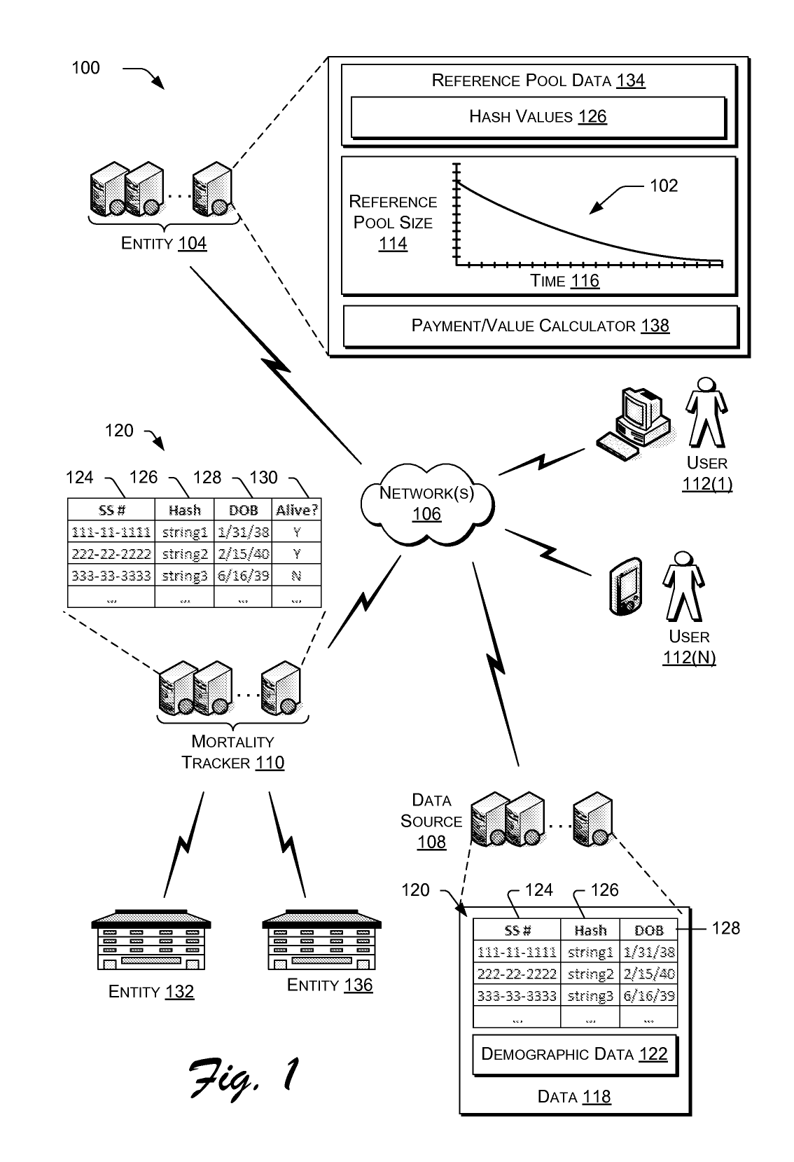

FIG. 1 illustrates an exemplary architecture that employs a longevity and mortality index to enable a market for a tradable financial product.

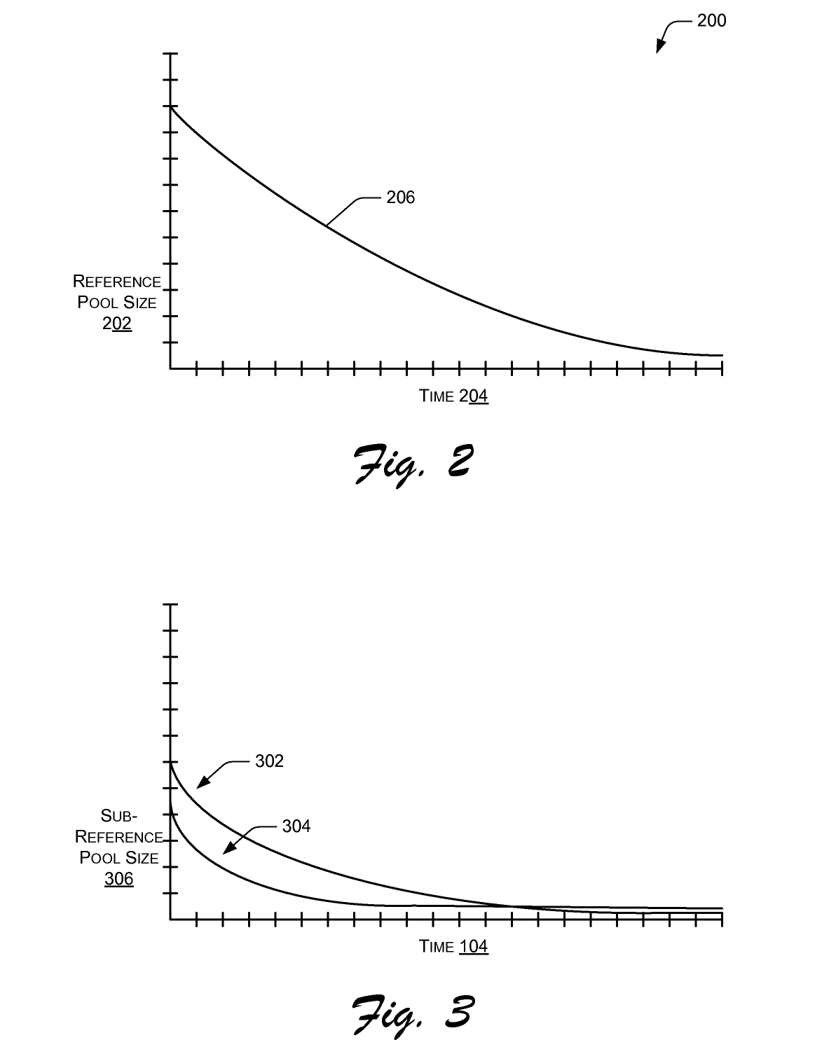

FIG. 2 illustrates an exemplary longevity and mortality index that may comprise a family of one or more sub-indices.

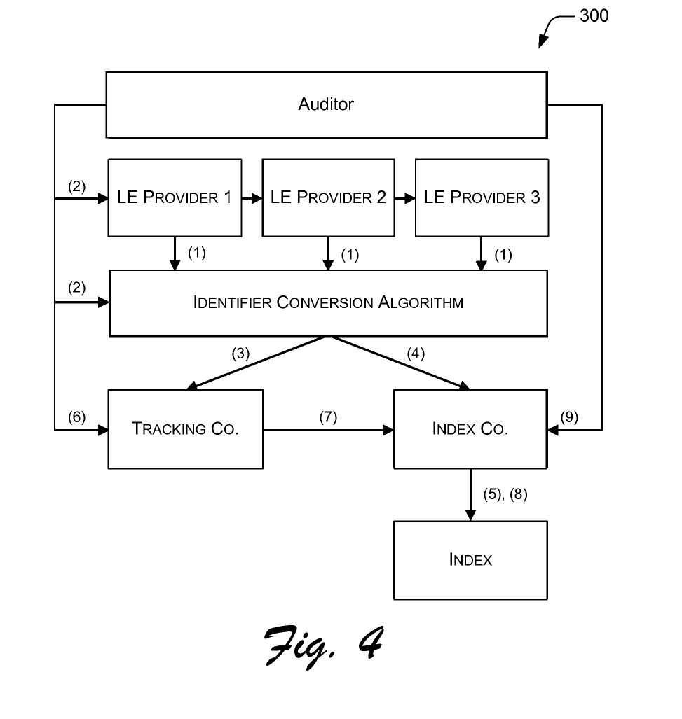

FIG. 3 illustrates exemplary sub-indices of the exemplary longevity and mortality index of FIG. 2.

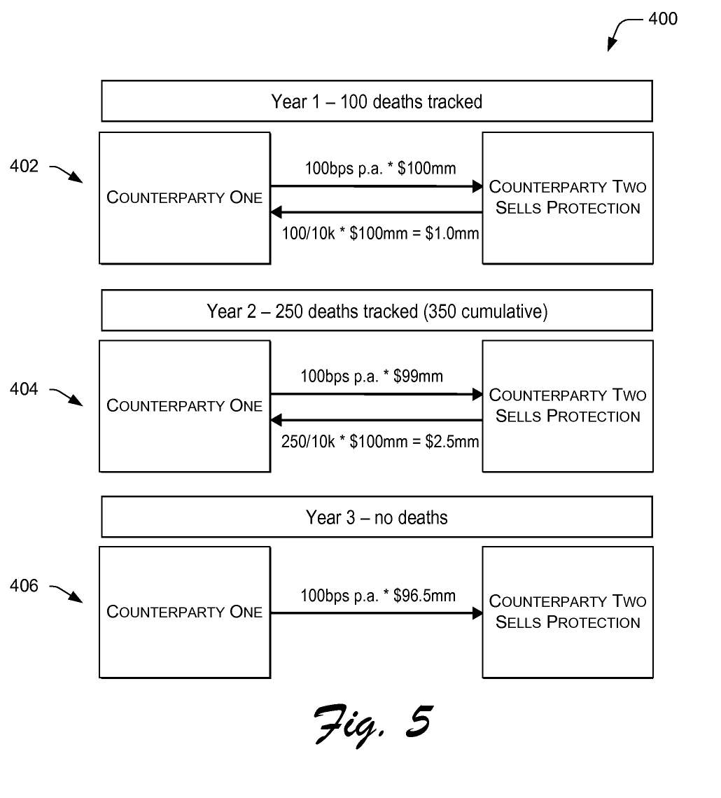

FIG. 4 illustrates one exemplary index design and entity structure.

FIG. 5 illustrates a pricing and trading example utilizing the longevity and mortality index of FIG. 1 or 2.

### DETAILED DISCUSSION

The document describes creation of one or more families of longevity and mortality indices, some or all of which may be tradable. In addition, this document describes tradable derivatives and other financial products whose value or payment obligations may tie in some manner to one or more of the created longevity and mortality indices. The discussion begins with an “Exemplary Architecture” in which a longevity and mortality index may be employed. A section entitled “Exemplary Indices” follows, and describes possible characteristics of the index of employed in the Exemplary Architecture of FIG. 1. A section entitled “Exemplary Index Design and Entity Structure” follows, before the discussion is concluded with an “Index Pricing and Trading Example.”

### Exemplary Architecture

FIG. 1 illustrates an exemplary architecture 100 that may employ a longevity and mortality index 102 to enable a market for one or more tradable financial products. As illustrated, architecture 100 includes an entity 104 that couples, via one or more networks 106, to a data source 108, a mortality tracker 110, as well as one or more users 112(1), . . . , (N), possibly operating client computing devices. In some instances, entity 104 functions to create index 102 to track mortality of a reference pool of multiple individuals. That is, entity 104 tracks how the size of a reference pool 114 declines over time 116. Entity 104 (and/or another entity) then calculates a value of one or more financial instruments based on the actual deaths tracked by index 102 over time.

To create index 102, data source 108 provides data 118 to entity 104 and mortality tracker 110. Data 118 may include identification data 120 that identifies one or more individuals (e.g., 5,000, 50,000, 1,000,000 etc.) of to be used as a particular reference pool. Data 118 may also include additional demographic data 122. Identification data 120 may include, for each of the multiple individuals of the reference pool, a social security number 124 of the respective individual, a hash value 126 of the respective social security number 124, and a date of birth 128 of the respective individual. By hashing social security numbers with a hash function, an individual may be anonymously tracked. Of course, it is specifically noted that in some instances, identification data 120 may include more, less and/or different identifying information than that illustrated in FIG. 1.

Demographic data 122, meanwhile, may include any other sort of data about each respective individual, such as a life expectancy for the individual, whether the individual exercises, whether the individual smokes, whether the individual qualifies for the senior settlement market, and/or any other data about the individual.

Data source 108 may provide identification data 120 to mortality tracker 110, which may store this data as illustrated by FIG. 1. With this data, mortality tracker 110 functions to verify the data provided by data source 108. After this data is verified, mortality tracker provides the information to entity 104, which employs the verified data to form the reference pool corresponding to longevity and mortality index 102. In addition, mortality tracker 110 functions to determine when each individual of the reference pool dies, as indicated by column 130. When such a determination is made, mortality tracker informs entity 104, which reflects the update in index 102, as discussed in more detail below.

To verify identification data 120, mortality tracker 110 may query one or more entities (e.g., commercial businesses, government entities, etc.) to provide birth dates corresponding to the stored social security numbers 124. For instance, mortality tracker 110 may provide an entity 132 with one or more of social security numbers 124, and may ask entity 132 to provide a birth date corresponding to that social security number in return. If the returned birth date stored by entity 132 corresponds or matches the birth date stored by mortality tracker 110 (illustrated in column 128), then mortality tracker 110 and entity 104 may include the corresponding individual in the reference pool tracked by index 102. Conversely, if the provided birth date does not match birth date 128, then mortality tracker 110 and/or entity 104 may exclude the corresponding individual from the reference pool.

Once mortality tracker 110 verifies identification data 120, entity 104 may begin tracking the mortality of the created reference pool, as illustrated by index 102. To do so, entity 104 stores or otherwise has access to reference pool data 134, which may include hash values 126. By storing hash values 126 rather than social security numbers 124, entity 104 is able to track individuals in the reference pool in an anonymous manner.

In order to enable the tracking of the mortality of the reference pool, mortality tracker 110 may periodically query an entity 136, which may comprise a government entity in some instances. Of course, entity 136 may also comprise any other type of entity in different implementations, such as commercial business or the like. Here, the government entity 136 may determine if and when individuals within the corresponding country or state die. As such, mortality tracker may communicate with the government entity to determine if and when individuals of the created reference pool die.

In some instances, mortality tracker 110 provides social security numbers 124 to entity 136. Entity 136 then informs mortality tracker 110 if any individuals corresponding to any of the provided social security numbers dies. If entity 136 does indeed report that one or more individuals associated with respective ones of the social security numbers have died, then mortality tracker 110 may map these social security numbers to corresponding ones of hash values 126. Mortality tracker 110 may then provide these hash values to entity 104, which then matches these values to those stored in hash values 126. With this information, entity 104 may then update the size of the reference pool and, hence, index 102. It is noted that entity 104 may update index 102 randomly, periodically (e.g., weekly, monthly, yearly, etc.), or according to any other schedule. Furthermore, entity 104 may similarly publish index 102 randomly, periodically (e.g., weekly, monthly, yearly, etc.), or according to any other schedule.

Entity 104 may further include or have access to a payment/value calculator 138. Payment/value calculator 138 may calculate one or more payments on a financial instrument based at least in part on index 102 and, hence, on the deaths of individuals in the corresponding reference pool. In addition or in the alternative, payment/value calculator 138 may merely calculate a value of one or more financial instruments based on index 102. These financial instruments may include, without limitation, swap agreements, options, tranches, notes, principally-protected notes, hedging products, derivatives and/or other type of financial instrument. Entity 104 may provide these instruments for sale, and/or may enable other entities to do so.

For instance, envision that user 112(1) and user 112(N) each enter into a swap agreement with entity 104, with payments of the swap agreement being based at least in part on the amortization of the reference pool associated with index 102. To do so, the swap agreement may state that payments made by one party is to be based on a fixed spread applied to an outstanding amount of an agreed-upon notional amount. The payments made by the other party, meanwhile, may be based on a realized mortality of the reference pool during a given time period.

Envision, for instance, that user 112(1) and entity 104 enter into a swap agreement where user 112(1) takes on a risk of increased longevity of the tracked reference pool, while entity 104 takes on the risk of increased longevity. Here, user 112(1) may make periodic payments to entity 104 based on a fixed spread (e.g., 500 basis points) of an agreed-upon notional amount (e.g., $10,000). Entity 104, meanwhile, may make periodic payments based on a number of deaths in the reference pool during the particular period of time. For instance, these periodic payments may be equal to the product of a percentage of deaths of the individuals in the reference pool during the corresponding period of time and the outstanding notional amount.

Using the example of the numbers in the immediate example, if more than five percent of the reference pool dies during the particular period (e.g., one month), then entity 104 makes a payment to user 112(1). Conversely, if less than five percent of the reference pool dies during the particular period, then user 112(1) makes a payment to entity 104. This process may repeat for each period (e.g., each month, year, etc.) of the agreed-upon term of the swap agreement (e.g., ten months, five years, ten years, etc.). In some instances, entity 104 may offer five and ten year swap agreements where index 102 is updated and cash flows triggered on a monthly basis. Additionally, because mortality tracker 110 is able to track deaths in the reference pool very close in time to when the death occurred, the updates of index 102 may reflect the deaths of those particular individuals who died in the corresponding period (e.g., within the last month).

User 112(N), meanwhile, may also enter into a swap agreement with entity 104, although in this instance, user 112(N) may bear the risk of increased longevity while entity 104 may bear the risk of increased mortality. Here, the roles of the user and the entity 104 may be reversed from the roles discussed above with regards to entity 104 and user 112(1).

In still further instances, entity 104 (and/or another entity) may offer other financial instruments for sale, with the future value and/or future payments associated with these instruments being tied in some manner to the amortization of the reference pool associated with of index 102. For instance, entity 104 may offer for sale to users 112(1)-(N) notes, tranches, options, derivatives, and the like. While users 112(1) and 112(N) are illustrated as individuals, it is specifically noted that purchasers of these financial instruments may also be companies or any other type of purchaser.

In the example of a note, a user such as user 112(1) may purchase a note for an agreed upon value, such as $10,000, and for an agreed-upon term, such as ten years. The user 112(1) may then choose to bear the risk of increased mortality or the risk of increased longevity. Using the latter instance as an example, entity 104 may make periodic payments to user 112(1) based on a number of deaths in the reference pool during each period (e.g., each month) and based on an outstanding amount of the note. These payments may be made directly to user 112(1) or may accrue in the principal of the note itself. These payments may then be netted against a fixed spread (e.g., 500 basis points) of the outstanding amount of the note. In instances where the payments made by entity 104 accrue in the principal of the note, the principal (e.g., the $10,000) either increases, decreases, or remains the same each period, depending upon the amortization of the reference pool associated with of index 102. At the end of the ten-year term, entity 104 then returns the balance of the principal of the note to user 112(1).

Furthermore, entity 104 may also offer for sale a note with principal protection. Here, some portion (e.g., 20%, 50%, 70%, etc.) of a principal of the note may be invested in bond, mutual fund, stock, and/or the like. The remaining portion may then be used in the manner discussed immediately above. That is, the user 112(1) may bear the risk of increased mortality or the risk of increased longevity.

### Exemplary Indices

FIG. 2 illustrates an exemplary longevity and mortality index 200 that may be employed in the architecture of FIG. 1. While index 200 is illustrated as a single index, index 200 may comprise an aggregation or more sub-indices as discussed below. Index 200 may thus be described as a family of sub-indices in some instances. In addition, while FIG. 1 illustrates single index 200, an index provider may create, utilize, or otherwise provide multiple longevity and mortality indices, each of which may include a family of sub-indices as described below. Note than an index provider may be a creator of the index, a company that lists the index, or any other entity or individual associated with the index and/or the index's usage in any way.

As illustrated, index 200 tracks a reference pool size 202 as it changes with time 204. The reference pool that index 200 tracks generally comprises a group of individuals. As line 206 illustrates, reference pool size 202 decreases or amortizes over time 204. In instances where the reference pool comprises a pre-determined beginning number (e.g., 1,000) of individuals, line 206 will decrease according to the number of individual deaths within the reference pool for each measured time period.

The reference pool that index 200 tracks may comprise any random or organized compilation of individuals. For instance, this reference pool may comprise a geographic area's (e.g., the United States) general population or a sampling thereof. This reference pool may also comprise the geographic area's life-insured population. In other instances, this reference pool may comprise a geographic area's senior settlement market. In still other instances, this reference pool may comprise any grouping of individuals, each of which may or may not share one or more common traits. Again, an index provider may also provide multiple indices, such as an index that tracks a geographic area's life-insured population and an index that tracks a geographic area's senior settlement market. If an index provider provides multiple indices in this manner, the index provider may construct each index with a same or different methodology and design.

Whatever the demographic of the reference pool, index 200 may update much faster than an index that merely cumulates census data. That is, because index 200 may actually track deaths of particular individuals, rather than citizens generically and as a whole, index 200 may reflect these deaths in a near-real time basis. For instance, mortality tracker 110 of FIG. 1 may readily determine when an individual of the reference pool dies, and may quickly provide this information to entity 104. Entity 104 may then include this death in the immediately-upcoming update and publishing of index 200. For instance, if entity 104 publishes an index such as index 200 on a monthly basis, each monthly update may reflect deaths of any individuals in the reference pool that died during that preceding month. The rapidity of these updates allows for cash flows to be triggered based on actual near real-time data, rather than only when stale census data is released. Furthermore, by tracking particular individuals, entity 104 is able to trigger cash flows according to a periodic schedule having relatively short periods (e.g., monthly).

As stated above, index 200 may sometimes comprise a family of sub-indices. FIG. 3, for instance, illustrates two sub-indices 302 and 304 that index 200 may include. While FIG. 3 illustrates but two sub-indices, index 200 may include any number of such sub-indices.

Again, sub-indices may track longevity and mortality of a sub-reference pool of the reference pool tracked by index 200. Similar to the reference pool of index 200, each sub-reference pool may comprise any random or organized compilation of individuals. For instance, a separate sub-index may track longevity and mortality of individuals within each of differing age groups, life expectancies, genders, states of residence, mortality multipliers, categories of medical impairment, smoking preferences (e.g., smokers/non-smokers), or the like. It is specifically noted that all listed reference pools and sub-reference pools are exemplary only, and many other reference and sub-reference pools may be utilized and are envisioned.

The provider of index 200 (e.g., entity 104) may create this index and its sub-indices in a number of ways. In some instances, the provider may license or otherwise acquire some or all of the pertinent longevity and mortality data from existing data pools. For instance, the provider may acquire this data from one or more life insurance companies, life expectancy (LE) providers, or the like. This data may include life expectancy data for the reference pools(s) and sub-reference pool(s).

In other instances, the index provider may itself track some or all of the pertinent longevity and mortality data so as to construct the data pools. In other instances, the index provider may utilize data that the provider already has or already tracks. In still other instances, the provider may obtain a portion of the data from existing data pools, may create another portion of the data, may utilize data that the provider already possesses, and/or may utilize data that the provider already tracks.

The index provider may then randomly or periodically update some or all of the acquired and/or created data that makes up index 200 and associated sub-indices. For instance, this data may update approximately every month. Of course, the index provider may also update this data more or less frequently.

In some instances, index 200 and/or its associated sub-indices may be tradable. For instance, two or more parties may enter into a contract for an exchange of cash flows or the like wherein the exchange may tie in some manner to index 200 and/or its sub-indices.

In one specific and non-limiting example, a first party may make periodic premium payments to a second party. The amount of these periodic payments may depend upon a number of agreed-upon basis points (bps) of an outstanding notional amount. In exchange, the second party may, for example, agree to take on the risk of increased mortality (or longevity) of the reference pool of index 200. The second party may therefore make periodic payments to the first party in amounts that are contingent upon the number of deaths in the index's reference pool for each period. In some instances, each periodic payment amount may comprise a product of the original notional amount and the percentage of the initial reference pool that dies in that period. FIG. 4 illustrates a specific example and is discussed below.

In addition, index 200 and/or its associated sub-indices may allow for the creation and trading of derivatives or any other tradable financial products that tie in some manner to index 200 and/or one or more of its sub-indices. Without limitation, these derivatives and/or products may include options, tranches, hedging products, index-linked notes, and the like, as discussed above.

For instance, imagine that a purchaser buys a note with coupons and/or a principal that links to index 200 and/or one or more of the index's sub-indices. The purchaser may thereafter receive periodic coupons, with each coupon's amount directly linking to the amortization of the reference pool(s) and/or sub-reference pool(s) to which the note links. While this example discusses coupons and/or a principal of the note linking to index 200 and/or the index's sub-indices, these coupons and/or principal may also link to one or more additional indices and/or one or more of each additional index's sub-indices.

Finally, and as will be appreciated, any of the processes and operations described above may be in hardware, software, or a combination thereof. This software may include computer-executable instructions that, when executed by one or more processors, perform the operations. Generally, computer-executable instructions include routines, programs, objects, components, data structures, and the like that perform particular functions or implement particular abstract data types. The order in which the operations have been described is not intended to be construed as a limitation, and any number of the described blocks can be combined in any order and/or in parallel to implement the process(es).

### Exemplary Index Design and Entity Structure

This sub-section describes, with reference to FIG. 3, an exemplary and non-limiting index design and entity structure 300 for creating and administering a longevity and mortality index. While FIG. 3 illustrates one potential entity structure, it is specifically noted that multiple other structures may be utilized and are envisioned.
1) LE providers may make identifiers (Name, SSN) and descriptive data (Age, Gender, DOB, LE, Impairment Factor, State of Residence) available and run identifiers through a common in-house software conversion algorithm
2) Auditor (i) may verify match between identifiers and descriptive data at LE Providers in-house and (ii) may verify conversion algorithm performance which assigns unidentifiable index codes by individual descriptive datasets
3) Tracking Co may be provided with unique identifiers with index codes
4) Index Co may receive descriptive data along with index codes by individual
5) Index Co (i) may select rules based subset (excl overlap between individuals across/within LE provider data) and (ii) may publish composite index+sub-index data
6) Auditor may verify Tracking Co determinations and mapping of deaths to index codes
7) Tracking Co may submit determined deaths by index codes to Index Co a period by period basis
8) Index Co may publish Index update
9) Auditor may verify Index Co determinations and calculations

### Index Pricing and Trading Example

This sub-section describes, with reference to FIG. 4, one index pricing and trading example 400. For this example, assume that the index Reference pool includes 10,000 lives at inception of the index. Also assume that cash flows between two parties (“Counterparty One” and “Counterparty Two”) of a swap agreement trigger on a yearly basis. Furthermore, the agreed-upon notional amount is $100 mm for a five year term. At the time of the swap agreement, the parties agreed to an index fixed spread of 100 basis point (bps) running paid on the outstanding or original notional.

With these exemplary numbers in mind, example 400 illustrates that at time 402 corresponding to the end of the first year, 100 of the 10,000 individuals in the reference pool have died. Therefore, Counterparty One, who bears the risk of increased longevity in the reference pool, is shown making a payment to Counterparty Two equal to 100 bps of the outstanding notional (here, $100 m). Counterparty Two, meanwhile, is shown making a payment to Counterparty One in an amount equal to a percentage equal to the number of deaths of the reference pool in the first year times the amount of the original or outstanding notional ($100 m in either instance). When these cash flows are netted against one another, each of these $1 m payments offsets one another, and no actual payment is made between the parties. The outstanding amount of the notional, however, has decreased by the $1 m attributable to the cash flow from Counterparty Two to Counterparty One.

Next, at time 404 (corresponding to the end of the second year), 250 more deaths of individuals in the reference pool have been tracked. Therefore, Counterparty One is shown making a payment to Counterparty Two equal to 100 bps of the outstanding notional (here, $99 m). This payment is equal to $0.99 m. Counterparty Two, meanwhile, is making a payment to Counterparty One in an amount equal to a percentage equal to the number of deaths of the reference pool in the first year times the amount of the original notional ($100 m). In other instances, however, note that this payment may be equal to the percentage of deaths times the outstanding notional amount (here, $99 m). As illustrated, however, the payment is equal to $2.5 m (2.5% of $100 m). When these cash flows are netted against one another, Counterparty Two makes a payment to Counterparty One in the amount of $1.51 m. In instances where the payment from Counterparty Two is based on the outstanding notional ($99 m) rather than the original notional ($100 m), the net payment from Counterparty Two to Counterparty One is in the amount of $1.485 m.

Finally, FIG. 4 illustrates a time 406 corresponding to the end of the third year of the five year term of the swap agreement. In the third year in this example, no deaths are tracked. As such, the only payment made is from Counterparty One to Counterparty Two in the amount of 100 bps of the outstanding notional ($96.5 m). While not illustrated, years four of five of the swap agreement may operate in manners similar to years 1-3, illustrated in FIG. 4 and discussed above.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more computer-readable media storing computer-executable instructions that, when executed on one or more processors, perform acts comprising:
analyzing a longevity and mortality index that tracks death of multiple individuals in a reference pool of the longevity and mortality index to determine a number of deaths of individuals in the reference pool during a particular period of time; and
calculating an amount of a payment to be made from a first party to a second party, wherein the amount of the payment is based, at least in part, on the determined number of deaths of individuals in the reference pool during the particular period of time.

2. One or more computer-readable media as recited in claim 1, wherein the multiple individuals in the reference pool comprise individuals in a particular geographical area.

3. One or more computer-readable media as recited in claim 1, wherein the multiple individuals in the reference pool comprise individuals in a particular geographical area that are insured by a life insurance policy.

4. One or more computer-readable media as recited in claim 1, wherein the multiple individuals in the reference pool comprise individuals in a particular geographical area that qualify for a senior settlement market.

5. One or more computer-readable media as recited in claim 1, wherein the multiple individuals in the reference pool comprise a general population in a particular geographical area or a sampling of the general population in the geographical particular area.

6. One or more computer-readable media as recited in claim 1, wherein the longevity and mortality index comprises at least two sub-indices, each of which tracks deaths of a subset of the multiple individuals in the reference pool.

7. One or more computer-readable media as recited in claim 1, wherein the particular period of time is one month.

8. One or more computer-readable media as recited in claim 1, wherein the calculating of the amount of the payment comprises multiplying: (i) an outstanding amount of a notional amount agreed upon by the first party and the second party with (ii) a percentage of the multiple individuals in the reference pool that died during the particular time period.

9. One or more computer-readable media as recited in claim 1, wherein the calculating of the amount of the payment comprises multiplying: (i) an outstanding amount of a notional amount agreed upon by the first party and the second party with (ii) a percentage of the multiple individuals in the reference pool that died during the particular time period;
and further comprising calculating an amount of a payment to be made from the second party to the first party, wherein the amount of the payment to be made from the second party to the first party comprises an agreed-upon percentage of the outstanding notional amount.

10. One or more computing devices, comprising:
one or more processors; and
the one or more computer-readable media storing the computer-executable instructions as recited in claim 1.

11. A method comprising:
creating a longevity and mortality index to track deaths of multiple individuals in a reference pool over time; and
offering for sale a financial product whose future value or future payment obligations link to the longevity and mortality index and the tracked deaths of the multiple individuals in the reference pool over time.

12. A method as recited in claim 11, wherein the financial product comprises a swap agreement, a derivative, an option, a tranche, a hedging product, or an index-linked note.

13. A method as recited in claim 11, wherein the multiple individuals in the reference pool comprise individuals in a particular geographical area.

14. A method as recited in claim 11, wherein the multiple individuals in the reference pool comprise individuals in a particular geographical area that are insured by a life insurance policy.

15. A method as recited in claim 11, wherein the multiple individuals in the reference pool comprise individuals in a particular geographical area that qualify for a senior settlement market.

16. A method as recited in claim 11, wherein the multiple individuals in the reference pool comprise a general population in a particular geographical area or a sampling of the general population in the geographical particular area.

17. A method as recited in claim 11, wherein the longevity and mortality index comprises at least two sub-indices, each of which tracks deaths of a subset of the multiple individuals in the reference pool.

18. A method comprising:
analyzing a longevity and mortality index that tracks death of multiple individuals in a reference pool of the longevity and mortality index to determine a number of deaths of individuals in the reference pool during a particular period of time; and
calculating an amount of a payment to be made from a first party to a second party, wherein the amount of the payment is based, at least in part, on the determined number of deaths of individuals in the reference pool during the particular period of time.

19. A method as recited in claim 18, wherein the multiple individuals in the reference pool comprise individuals in a particular geographical area.

20. A method as recited in claim 18, wherein the multiple individuals in the reference pool comprise individuals in a particular geographical area that are insured by a life insurance policy.

21. A method as recited in claim 18, wherein the multiple individuals in the reference pool comprise individuals in a particular geographical area that qualify for a senior settlement market.

22. A method as recited in claim 18, wherein the multiple individuals in the reference pool comprise a general population in a particular geographical area or a sampling of the general population in the geographical particular area.

23. A method as recited in claim 18, wherein the longevity and mortality index comprises at least two sub-indices, each of which tracks deaths of a subset of the multiple individuals in the reference pool.

24. A method as recited in claim 18, wherein the calculating of the amount of the payment comprises multiplying: (i) an outstanding amount of a notional amount agreed upon by the first party and the second party with (ii) a percentage of the multiple individuals in the reference pool that died during the particular time period.

25. A method as recited in claim 18, wherein the calculating of the amount of the payment comprises multiplying: (i) an outstanding amount of a notional amount agreed upon by the first party and the second party with (ii) a percentage of the multiple individuals in the reference pool that died during the particular time period;
and further comprising calculating an amount of a payment to be made from the second party to the first party, wherein the amount of the payment to be made from the second party to the first party comprises an agreed-upon percentage of the outstanding notional amount.

26. One or more computing devices, comprising:
one or more processors; and
one or more computer-readable media storing computer-executable instructions that, when executed on the one or more processors, perform the method as recited in claim 18.
